(19) United States
(12) Patent Application Publication
(10) Pub. No.: US 2008/0092439 A1
(43) Pub. Date: Apr. 24, 2008

(54) Tree stake

(76) Inventor: James Banks, Rockwall, TX (US)

Correspondence Address: WILSON DANIEL SWAYZE, JR., 3804 CLEARWATER CT., PLANO, TX, 75025, US

(21) Appl. No.: 11/550,432

(22) Filed: Oct. 18, 2006

(51) Int. Cl. A01G 17/14

(52) U.S. Cl. 47/47

(57) ABSTRACT

A tree stake for the staking of a tree having a root ball includes a first anchor member for anchoring the tree stake, a central longitudinal member to support the tree and a first traverse member to connect the first anchor member and the central longitudinal member.

### BACKGROUND OF THE INVENTION

The present invention generally relates to the care and maintenance of young trees, and more particularly relates to the practice of staking young trees to keep them in an upright position.

Staking of a young tree most commonly involves strapping the tree to one or more stakes to keep the tree from swaying in the wind. The usual approach to staking a tree in the ground is to strap the tree's trunk to two stakes set well apart in the soil on opposite sides of the tree. For a very young tree in a planter box with limited space, a single stake is normally used. This is usually a smaller temporary stake strapped directly to the tree's trunk. The tree is kept in an upright position by staking until it is strong enough to support its own weight, and until it can withstand normal wind conditions without damage or breakage.

Referring now to the drawings, FIG. 1 shows a conventional prior art approach to staking a young tree, wherein trunk 11 of tree 13 is held to stakes 15 by straps 17, each of which is tied to one of the stakes 15 by wrapping the strap around the tree trunk. With straps pulling from each direction, the tree is tightly girded with the object of preventing the tree from swaying in the wind. The stakes for this purpose are usually driven into the ground opposite each other in line with prevailing winds. The stakes are shown as being driven through the tree's root ball 21.

Such known staking methods have disadvantages which are detrimental to the tree's health and proper growth. Driving the stakes through the root ball 21 inherently damages the root ball by cutting some of the roots that are in the path of the stakes. U.S. Pat. No. 5,568,700 illustrates one such device.

### SUMMARY OF THE INVENTION

The present invention overcomes the above-mentioned disadvantages of conventional staking methods by providing a device for supporting a young tree to a stake which holds the tree in an upright position, but which also does not penetrate the root ball of a young tree.

The tree stake of the present invention is stable and avoids being tipped over.

The present invention includes a anchor device which anchors the tree stake and has sufficient distance between the anchor members so that the anchor members do not penetrate the root ball of the young tree. The distance between the anchor members are such that the anchor members will accommodate various sized small trees and the associated root balls. The anchor members are connected to a central longitudinal member and maybe equidistant to the central longitudinal member. The central longitudinal member may be integral with one or more of the anchor members or may be attached to the anchor members. An elastomeric cord may be used to attach the central longitudinal member to the young tree.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a tree stake;

FIG. 2 illustrates a perspective view of the tree stake of the present invention;

FIG. 3 illustrates another embodiment of the tree stake of the present invention;

FIG. 4 illustrates a perspective view of the tree stake of the present invention holding a tree;

FIG. 5 illustrates a exploded view of the tree stake of the present invention; and

FIG. 6 illustrates a bottom view of the tree stake of the present invention.

### DETAILED DESCRIPTION

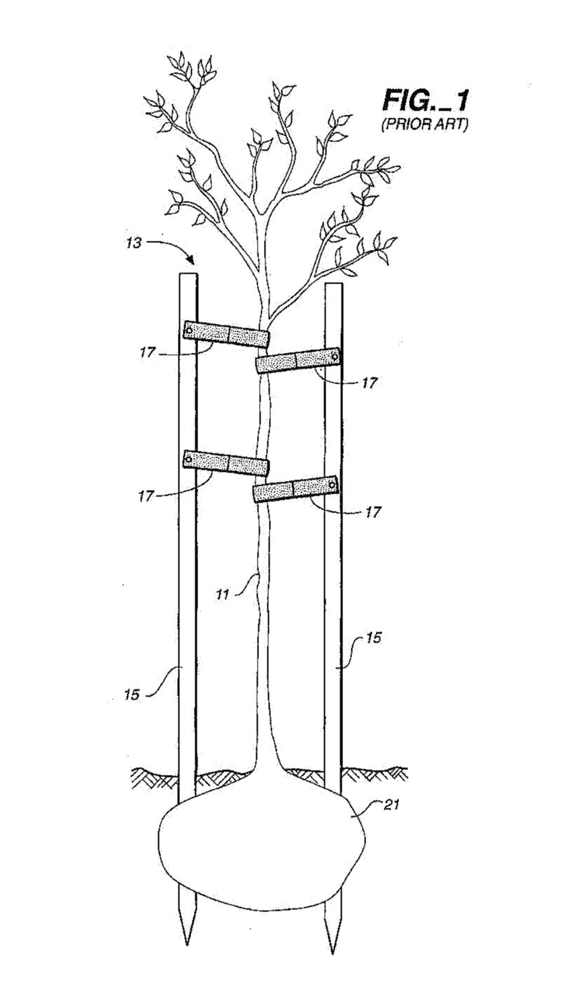

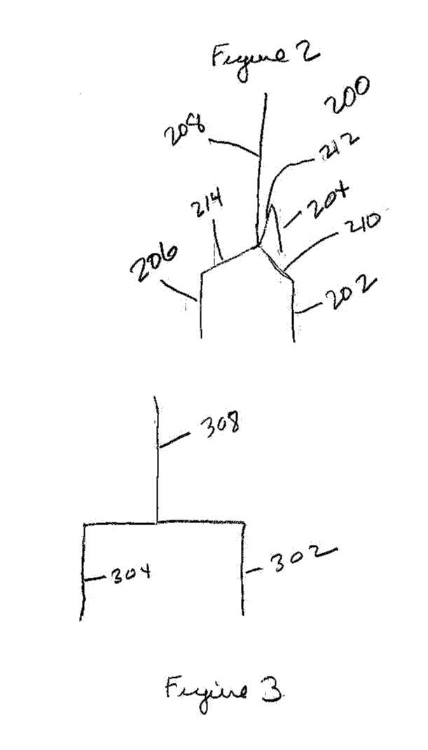

FIG. 1 illustrates a perspective view of the tree stake 200 of the present invention. The tree stake 200 may be formed from rigid rods of metal including steel, plastic, wood or other such suitable material. The tree stake 200 includes a first anchor member 202, a second anchor member 204 and a third anchor member 206. The first anchor member 202, the second anchor member 204 and the third anchor member 206 may be formed from rigid rods which are positioned so that the first anchor member 202, the second anchor member 204 and the third anchor member 206 surround the periphery of the root ball of the young tree without the need to penetrate the root ball. The anchor members 202, 204, 206 are formed in the general longitudinal direction of the tree stake 200. The anchor members 202, 204, 206 form a stable base for the tree stake 200. The central longitudinal member 208 is formed in the general longitudinal direction of the tree stake 200. The central longitudinal member 208 can be connected to the young trees by various straps at varying heights.

The central longitudinal member 204 and the first anchor member 202 are connected to the first traverse member 210 at opposing ends of the first traverse member 210, and the central longitudinal member 204 and a second anchor member 204 are connected to the second traverse member 212 at opposing ends of the second traverse member 212. The central longitudinal member 204 and the third anchor member 206 are connected to the third traverse member 214 at opposing ends of the third traverse member 214. The central longitudinal member 214 forms approximately a right angle with the first traverse member 210, the second traverse member 212, and the third traverse member 214. The first anchor member 202, the second anchor member 204 and the third anchor member 206 form a approximate right angle with the first traverse member 210, the second traverse member 212 and the third traverse member 214, respectively. Other angles are within the scope of the present invention.

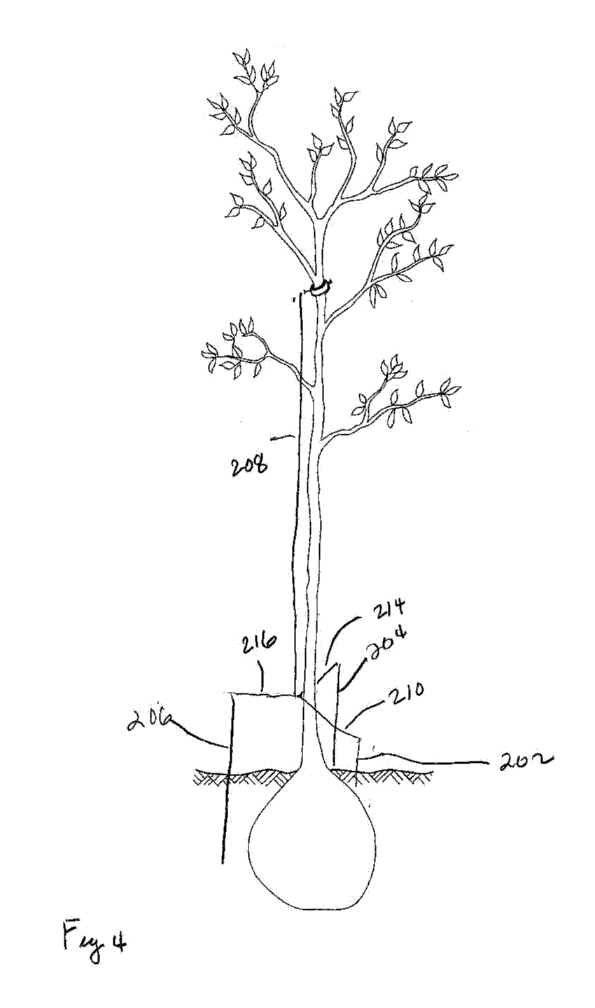

FIG. 3 illustrates another embodiment of the present invention and illustrates that the present invention may have fewer or greater number of anchor members. For example, FIG. 3 illustrates a first anchor member 302 and a second anchor member 304.

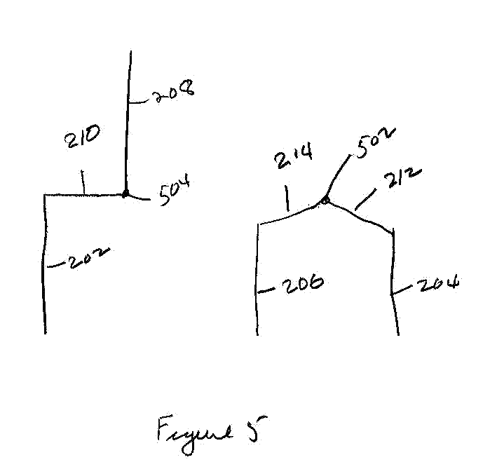

FIG. 4 illustrates that the first anchor member 202, the second anchor member 204 and the third anchor member 206 are placed around and in close proximity to the periphery of the tree ball, and as a consequence, the central longitudinal member 208 is positioned close to the tree.

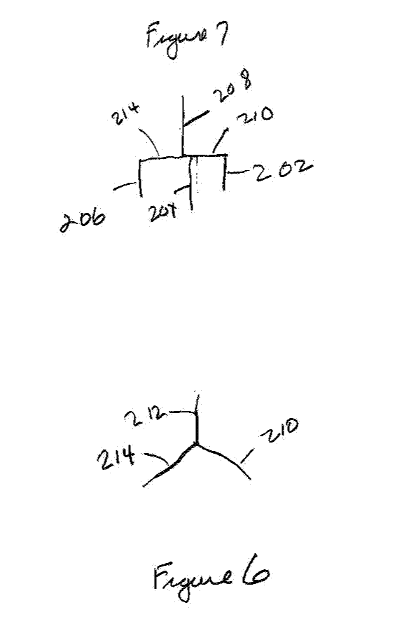

FIG. 5 illustrates one method of constructing the tree stake 200 by forming the first anchor member 200 integral with the first traverse member 210 and the central longitudinal member of 208. The second anchor member 204 and the second traverse member 212 are integral with the third anchor member 206 and the third traverse member 214. The first connecting point 502 between the second traverse member 212 and the third traverse member 214 is connected to the second connection point 504 between the first traverse member 210 and the central longitudinal member 208.

FIG. 6 illustrates a bottom view of the tree stake 200 and showing the first traverse member 210, the second traverse member 212 and the third traverse member 214.

FIG. 7 illustrates a side view of the tree stake 200 showing the first anchor member 202, the second anchor member 204, the third anchor member 206, the central longitudinal member of 208, the first traverse member 212 and the third traverse member 214.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A tree stake for the staking of a tree having a tree ball, comprising;
a first anchor member for anchoring the tree stake;
a central longitudinal member to support said tree;
a first traverse member to integrally connect said first anchor member and said central longitudinal member:
wherein said tree stake further includes a second anchor member for anchoring the tree stake, a second traverse member to connect said second anchor member to said central longitudinal member and wherein said tree stake further includes a third anchor member for anchoring the tree stake and a third traverse member to integrally connect to said second anchor member.

2) A tree stake for the staking of a tree having a tree ball as in claim 1, wherein said first anchor member is positioned outside of said periphery of said tree ball.

3) (canceled)

4) (canceled)

5) A method for forming a tree stake for the staking of the tree, comprising:
integrally forming a first anchor member for anchoring said tree stake, a central longitudinal member to connect with said tree and a first traverse member to integrally connect said first anchor member to said central longitudinal member;
integrally forming a second anchor member for anchoring the tree stake, a second traverse member to connect said second anchor member to said central longitudinal member and to integrally connect to a third anchor member for anchoring the tree stake and a third traverse member to connect said third anchor member to said central longitudinal member.
